(19) United States
(12) Patent Application Publication
(10) Pub. No.: US 2021/0252827 A1
(43) Pub. Date: Aug. 19, 2021

(54) COMPOSITE MATERIAL STRUCTURE

(71) Applicant: Freudenberg & Vilene Nonwovens (Taiwan) Co., Ltd., Taoyuan (TW)

(72) Inventors: Chi-Yin Lee, Hong Kong (HK); Jian-Hao Chien, Taoyuan City (TW); Wan-Ting Hu, Taoyuan City (TW)

(73) Assignee: Freudenberg & Vilene Nonwovens (Taiwan) Co., Ltd., Taoyuan (TW)

(21) Appl. No.: 16/980,424

(22) PCT Filed: Jun. 8, 2018
(86) PCT No.: PCT/CN2018/090390

§ 371 Date: Sep. 14, 2020

Related U.S. Application Data
(60) Provisional application No. 62/643,768, filed on Mar. 16, 2018.

(51) Int. Cl. B32B 5/26; B32B 5/02

(52) U.S. Cl. CPC B32B 5/26; B32B 5/02; B32B 2270/00; B32B 2262/0292; B32B 2262/0261; B32B 2274/00; B32B 2262/0215; B32B 2255/02; B32B 2255/26; B32B 2262/0246; B32B 2250/04; B32B 2250/20; B32B 2262/0276

(57) ABSTRACT

The invention provides a composite material structure, including a first cloth layer, a second cloth layer, a breathable thermoplastic material layer, and a lining cloth layer. The breathable thermoplastic material layer is located between the first cloth layer and the second cloth layer and disposed on the first cloth layer. The lining cloth layer is located between the first cloth layer and the second cloth layer, and is formed by a base cloth and a dispensing layer, and the base cloth is disposed on the second cloth layer via the dispensing layer. Therefore, the breathability and comfort of the clothing, the uniformity of elasticity, and the flexibility of design may be improved, and the composite material structure is especially suitable for sportswear or personal clothing.

### BACKGROUND

### Technical Field

The invention relates to a composite material structure, in particular to a composite material structure that may improve air permeability, elastic uniformity, and design flexibility of clothing.

### Description of Related Art

Generally speaking, a laminating structure may be used in clothing to make the appearance more aesthetic and provide a shaping function (adjust the body shape by laminating a double-layer structure in a specific area). In the prior art, as shown in FIG. 1, the laminating structure mostly adopts a thermoplastic film, and a layer of thermoplastic film 12 is sandwiched between two cloth layers 10. This existing structure has the shortcomings of lack of breathability and poor comfort and ductility, especially when used in sportswear or fitting clothing, and the elasticity may be affected by a high-temperature hot-press process. When the temperature is raised, the elasticity may be decreased, and the issue of uneven elasticity may also occur.

Based on the above, the development of a composite material structure suitable for clothing to alleviate the shortcomings of lack of breathability, poor comfort, and decreased and uneven elasticity of the existing laminating structure is an important subject for current research.

### SUMMARY

The invention provides a composite material structure that may improve the breathability and comfort of clothing, the uniformity of elasticity, and the flexibility of design, and the composite material structure is especially suitable for sportswear or personal clothing.

A composite material structure of the invention includes a first cloth layer, a second cloth layer, a breathable thermoplastic material layer, and a lining cloth layer. The breathable thermoplastic material layer is located between the first cloth layer and the second cloth layer and disposed on the first cloth layer. The lining cloth layer is located between the first cloth layer and the second cloth layer, and is formed by a base cloth and a dispensing layer, and the base cloth is disposed on the second cloth layer via the dispensing layer.

In an embodiment of the invention, the breathable thermoplastic material layer includes a dispensing structure or a mesh made of a thermoplastic material.

In an embodiment of the invention, a material of the base cloth includes a copolymer or a blend of thermoplastic polyurethane (TPU), polyethersulfone (PES), polyamide (PA), thermoplastic polyurethane elastomer (TPU), thermoplastic polyester elastomer (TPEE), or a combination thereof.

In an embodiment of the invention, the dispensing layer is made by a dispensing process, including coating a polymer resin colloid on the second cloth layer.

In an embodiment of the invention, the dispensing structure is made by a dispensing process, including coating a polymer resin colloid on the first cloth layer.

In an embodiment of the invention, the polymer resin colloid includes a copolymer or a blend of polyethersulfone (PES), polyamide (PA), thermoplastic polyurethane elastomer (TPU), polyethylene (PE), polymethyl methacrylate (PMMA), or a combination thereof.

In an embodiment of the invention, the thermoplastic material includes a copolymer or a blend of polyethersulfone (PES), polyamide (PA), thermoplastic polyurethane elastomer (TPU), polyethylene (PE), polymethyl methacrylate (PMMA), or a combination thereof.

Based on the above, the composite material structure of the invention includes a lining cloth layer composed of a base cloth and a dispensing layer, and a breathable thermoplastic material layer. The gaps in the dispensing layer and the breathable thermoplastic material layer may provide good breathability and improve comfort. Moreover, the elasticity of the composite structure of the invention may be adjusted via the selection of the base cloth in the lining cloth layer. Compared with the thermoplastic film used in the existing structure, the lining cloth layer used in the composite material structure of the invention does not melt during a high-temperature fusion process. In this way, the composite material structure of the invention is relatively insensitive to heat, and therefore elasticity is not affected by a high-temperature process, and therefore, uniform elasticity may be provided in the process. Moreover, in the invention, different composite material elasticities may be created by using interlining cloths having different elasticities, and therefore more flexibility in design may be achieved.

In order to make the above features and advantages of the invention better understood, embodiments are specifically provided below with reference to figures for detailed description as follows.

### BRIEF DESCRIPTION OF THE DRAWINGS

FIG. 1 is a diagram of an existing laminating structure.

FIG. 2 is a diagram of a composite material structure according to an embodiment of the invention.

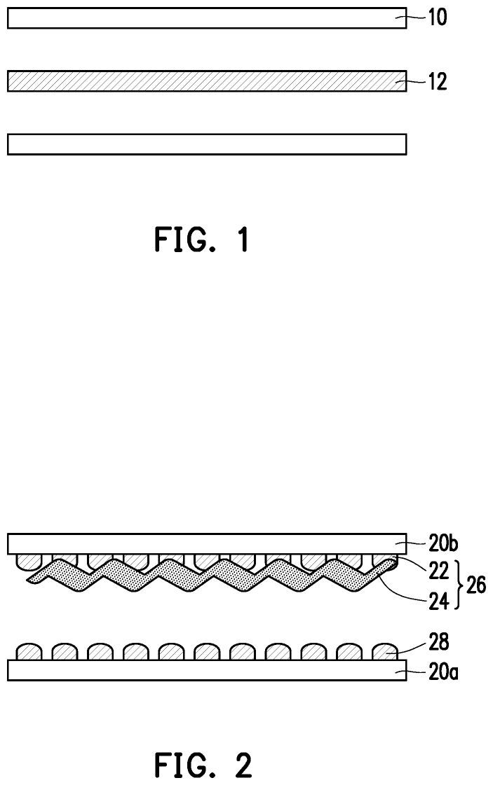

### REFERENCE SIGNS LIST

10: Cloth layer;
12: Thermoplastic film;
20a: First cloth layer;
20b: Second cloth layer;
22: Dispensing layer;
24: Base cloth;
26: Lining cloth layer;
28: Breathable thermoplastic material layer.

### DESCRIPTION OF THE EMBODIMENTS

In the present specification, for clarity, the size and proportion of layers and areas in the figures may be exaggerated. In addition, the number of dispensing in the dispensing layer or the dispensing structure shown is only for illustrative purposes, and the invention is not limited thereto, and adjustments may be made according to actual operating conditions.

FIG. 2 is a diagram of a composite material structure according to an embodiment of the invention.

Please refer to FIG. 2, the composite material structure includes a first cloth layer 20a, a second cloth layer 20b, a breathable thermoplastic material layer 28, and a lining cloth layer 26. In more detail, the breathable thermoplastic material layer 28 and the lining cloth layer 26 are both located between the first cloth layer 20a and the second cloth layer 20b. The breathable thermoplastic material layer 28 is disposed on the first cloth layer 20a to improve wearing comfort and breathability. The lining cloth layer 26 is composed of a base cloth 24 and a dispensing layer 22. The base cloth 24 is disposed on the second cloth layer 20b via the dispensing layer 22. Therefore, not only may the dispensing layer 22 improve the wearing comfort and breathability, compared to the thermoplastic film used in the existing structure, the base cloth 24 of the lining cloth layer 26 is less sensitive to heat, and therefore elasticity is not affected by a high-temperature process.

In the present embodiment, the breathable thermoplastic material layer 28 may include a dispensing structure (as shown in FIG. 2) or a mesh made of a thermoplastic material, wherein the thermoplastic material may include a copolymer or a blend of polyethersulfone (PES), polyamide (PA), thermoplastic polyurethane elastomer (TPU), polyethylene (PE), polymethyl methacrylate (PMMA), or a combination thereof, but the invention is not limited thereto. That is, even though the breathable thermoplastic material layer 28 shown in FIG. 2 has a dispensing structure, other breathable thermoplastic materials or processes may also be used as appropriate. The material of the base cloth 24 may include a copolymer or a blend of thermoplastic polyurethane (TPU), polyethersulfone (PES), polyamide (PA), thermoplastic polyurethane elastomer (TPU), thermoplastic polyester elastomer (TPEE), or a combination thereof. However, the invention is not limited thereto. Other elastic cloths may be used as appropriate to control the elasticity of the composite structure of the invention, and base cloths 24 having different elasticities, stretch recovery rates, and size specifications may also be used to improve design flexibility.

In the present embodiment, the dispensing layer 22 and the breathable thermoplastic material layer 28 adopting a dispensing structure may be made by a dispensing process. For example, a polymer resin colloid may be coated on the first cloth layer 20a to form the breathable thermoplastic material layer 28 adopting a dispensing structure; a polymer resin colloid may be coated on the second cloth layer 20b to make the dispensing layer 22. The polymer resin colloid may include a copolymer or a blend of polyethersulfone (PES), polyamide (PA), thermoplastic polyurethane elastomer (TPU), polyethylene (PE), polymethyl methacrylate (PMMA), or a combination thereof. However, the invention is not limited thereto.

Based on the above, the composite material structure of the invention includes a lining cloth layer composed of a base cloth and a dispensing layer and a breathable thermoplastic material layer, and is particularly suitable for sportswear or personal clothing. Compared with the existing laminating structure using thermoplastic film, in the invention, the air permeability, comfort, and ductility of clothing may be improved via the gaps in the dispensing layer and the breathable thermoplastic material layer, and elasticity is not affected by a high-temperature process, and therefore elastic uniformity may be further improved. Moreover, in the invention, the elasticity of the composite structure of the invention may be adjusted via the selection of the base cloth in the lining cloth layer, and different composite material elasticities may also be created by using lining cloths having different elasticities. Therefore, more flexibility may be achieved in design.

Although the invention is disclosed as above by the embodiments, the embodiments are not intended to limit the invention. Any person skilled in the art may make some changes and modifications without departing from the spirit and scope of the invention. Therefore, the scope of the invention shall be subject to what is defined in the claims.

What is claimed is:

1. A composite material structure, comprising:
a first cloth layer;
a second cloth layer;
a breathable thermoplastic material layer located between the first cloth layer and the second cloth layer and disposed on the first cloth layer; and
a lining cloth layer located between the first cloth layer and the second cloth layer and formed by a base cloth and a dispensing layer, and the base cloth is disposed on the second cloth layer via the dispensing layer.

2. The composite material structure of claim 1, wherein the breathable thermoplastic material layer comprises a dispensing structure or a mesh made of a thermoplastic material.

3. The composite structure of claim 1, wherein a material of the base cloth comprises a copolymer or a blend of thermoplastic polyurethane, polyethersulfone, polyamide, thermoplastic polyurethane elastomer, thermoplastic polyester elastomer, or a combination thereof.

4. The composite material structure of claim 1, wherein the dispensing layer is made by a dispensing process, comprising coating a polymer resin colloid on the second cloth layer.

5. The composite material structure of claim 4, wherein the polymer resin colloid comprises a copolymer or a blend of polyethersulfone, polyamide, thermoplastic polyurethane elastomer, polyethylene, polymethyl methacrylate, or a combination thereof.

6. The composite material structure of claim 2, wherein the thermoplastic material comprises a copolymer or a blend of polyethersulfone, polyamide, thermoplastic polyurethane elastomer, polyethylene, polymethyl methacrylate, or a combination thereof.

7. The composite material structure of claim 2, wherein the dispensing structure is made by a dispensing process, comprising coating a polymer resin colloid on the first cloth layer.

8. The composite material structure of claim 7, wherein the polymer resin colloid comprises a copolymer or a blend of polyethersulfone, polyamide, thermoplastic polyurethane elastomer, polyethylene, polymethyl methacrylate, or a combination thereof.
